(19) United States
(12) Patent Application Publication
(10) Pub. No.: US 2010/0207309 A1
(43) Pub. Date: Aug. 19, 2010

(54) REGENERATIVE DAMPING APPARATUS FOR VEHICLE

(76) Inventor: Kyu Shik PARK, Seoul (KR)

Correspondence Address: MCDERMOTT WILL & EMERY LLP, 600 13TH STREET, N.W., WASHINGTON, DC, 20005-3096, US

(21) Appl. No.: 12/707,059

(22) Filed: Feb. 17, 2010

(30) Foreign Application Priority Data
Feb. 17, 2009 (KR) 10-2009-0012896

(51) Int. Cl. F16F 7/00; H02K 7/18

(52) U.S. Cl. 267/195; 290/1 A

(57) ABSTRACT

The present disclosure relates a regenerative damping apparatus for a vehicle utilizing an electric generator. An object of the present disclosure is to provide a separate regenerative damping apparatus for a vehicle in which a motion due to the vibration and/or the shock generated while the vehicle is driven is converted into a rotational motion, so as to provide a regenerative damping apparatus for the vehicle in which an electric generator is allowed to regenerate the energy which would be lost, thereby capable of reducing the noise to be generated and maintaining the driving comfort of the vehicle and/or the damping performance due to its shock absorber. In order to achieve the above object, the regenerative damping apparatus for a vehicle according to the present disclosure comprises a suspension link having one end mounted to a road wheel; and an electric generator fixed to a vehicle body with the other end of the suspension link is connected to the electric generator, thereby generating electricity by means of the rotation of the suspension link.

### BACKGROUND

1. Technical Field

The present disclosure relates to a regenerative damping apparatus for a vehicle utilizing an electric generator, and more particularly, to a regenerative damping apparatus for a vehicle, which can regenerate the energy generated in the process for damping the vibration and/or the shock transmitted from a rod surface while the vehicle is driven.

2. Description of the Related Art

In general, a shock absorber is mounted to a transportation means such as a vehicle and the like, so that it absorbs and damps the vibration and/or shock transmitted from a road surface to enhance driving comfort when the vehicle is driven.

The shock absorber comprises a cylinder and a piston rod mounted in the cylinder in the compression and rebound manner, and the cylinder and the piston rod are mounted to a vehicle body and a road wheel or a vehicle shaft, respectively.

In the shock absorber, the piston rod is reciprocated in the process for absorbing the vibration and/or the shock. In recent, there has been an attempt for using the energy generated during the reciprocation of the piston rod to generate other regenerated energy.

In a conventional regenerative damping apparatus for a vehicle, an electric generator is mounted to a vehicle body, and the reciprocating motion of the piston rod is converted into the rotational motion which is transferred to the electric generator. To this end, the regenerative damping apparatus has a motion-converting device for converting the reciprocating motion into the rotational motion.

A ball screw device may be employed as the motion-converting device. The ball screw device is connected to the piston rod so that the ball screw is rotated in response to the reciprocating motion of the piston rod, and therefore this rotational force is transferred to the electric generator so that the electricity may be generated.

Such a conventional linear-type regenerative damping apparatus as described above is disclosed in U.S. Pat. No. 6,952,060 and the like, and has been mounted instead of the shock absorber.

In the conventional linear-type regenerative damping apparatus, however, the ball screw device utilized for converting the reciprocating motion into the rotational motion allows the starting frictional force to be increased, so that a noise may be generated and the driving comfort may be degraded. In addition, although the linear-type regenerative damping apparatus as described above has been mounted instead of the shock absorber, the performance in the damping force thereof is degraded compared with the shock absorber, and therefore the overall driving comfort and/or the driving performance of the vehicle has been degraded.

### BRIEF SUMMARY

Accordingly, the present disclosure is conceived to solve the aforementioned problems in the prior art. An object of the present disclosure is to provide a separate regenerative damping apparatus for a vehicle in which a motion due to the vibration and/or shock generated while the vehicle is driven is converted into a rotational motion, so as to provide a regenerative damping apparatus for the vehicle in which an electric generator is allowed to regenerate the energy which would be lost, thereby capable of reducing the noise to be generated and maintaining the driving comfort of the vehicle and/or the damping performance due to its shock absorber.

In order to achieve the above object, a regenerative damping apparatus for a vehicle according to the present disclosure for damping the vibration transmitted from a road surface and for regenerating the vibration energy of the vehicle into the electrical energy when the vehicle is driven, comprises an electric generator mounted to a vehicle body at a place spaced apart from a lower arm by a certain distance in the lengthwise direction of the vehicle, the lower arm having one end mounted to the vehicle body pivotally upward and downward and the other end connected to a road wheel to support the road wheel; and a suspension link having one end connected to the lower arm and the other end connected to the electric generator, wherein when the lower arm is pivoted upward and downward, the suspension link rotates around a central axis of the electric generator so that the electricity is generated.

Preferably, the regenerative damping apparatus further comprises a transmission mounted between the electric generator and the other end of the suspension link to change a rotational speed.

It is preferable that the electric generator include a rotor rotatably mounted to a housing and having a permanent magnet; and a coil surrounding the rotor to generate the electricity when the rotor rotates.

It is preferable that the electric generator further include an electric power source for supplying the coil with current; and an electronic control unit for controlling the current to be supplied to the coil, wherein the current supplied to the coil in the electric generator rotates the rotor and the suspension link connected thereto so that damping force at the road wheel is changed.

It is preferable that the regenerative damping apparatus further comprises a shock absorber or a coil spring mounted between the vehicle body and the road wheel.

### BRIEF DESCRIPTION OF THE SEVERAL VIEWS OF THE DRAWINGS

FIG. 1 is a front view illustrating a regenerative damping apparatus for a vehicle according to the present disclosure; and

FIG. 2 is a plan view illustrating a regenerative damping apparatus for a vehicle according to the present disclosure.

### DETAILED DESCRIPTION

Hereinafter, a preferred embodiment of the present disclosure will be described in detail with reference to the accompanying drawings.

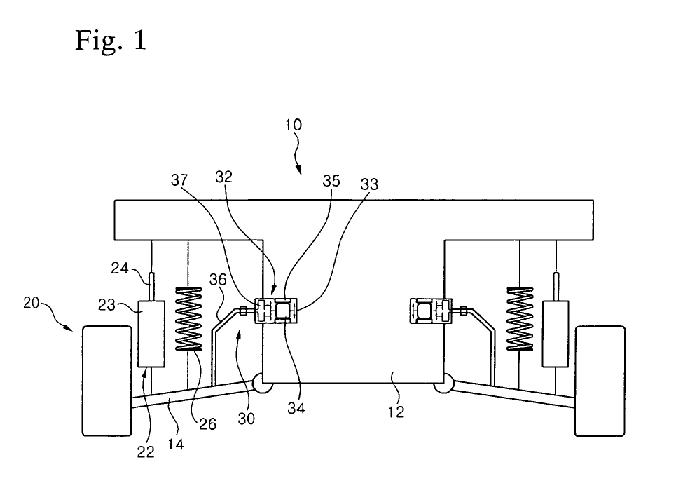

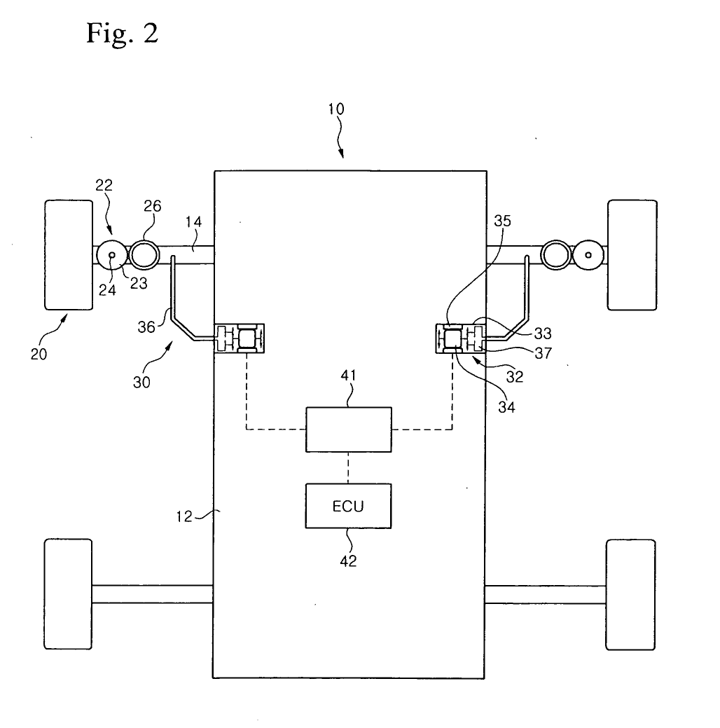

FIG. 1 is a front view illustrating a regenerative damping apparatus for a vehicle according to the present disclosure, and FIG. 2 is a plan view illustrating a regenerative damping apparatus for a vehicle according to the present disclosure.

As shown in FIGS. 1 and 2, a regenerative damping apparatus 30 according to the present disclosure is mounted to a vehicle body 10, so that it may utilize a reciprocating motion due to the vibration or the shock transmitted from a road wheel 20 to regenerate the energy which would be lost.

A shock absorber 22 comprises a cylinder 23 and a piston rod 24 mounted to be capable of being reciprocated in the cylinder 23. While the vehicle is driven, the vibration and/or the shock transmitted from the road wheel 20 allows the piston rod 24 of the shock absorber 22 to be extended/contracted from the cylinder 23 so that the vibration and/or the shock may be absorbed.

To this end, the cylinder 23 is filled with an operation fluid such as gas or oil, a piston valve (not shown) mounted to an end portion of the piston rod 24 allows the flow of the operation fluid in the cylinder 23 to be controlled to generate the damping force.

The vehicle body 10 comprises a cross member 12 and a lower arm 14 restricted by the cross member 12 to enable the lower arm to be moved upward and downward. This lower arm 14 supports the road wheel 20. And, the shock absorber 22 is coupled to the lower arm 14 to absorb the vibration and/or the shock transmitted from the road wheel 20.

In addition, a coil spring 26 is mounted in the vehicle for absorbing the vibration and/or the shock transmitted from a road surface together with the shock absorber 22. The coil spring 26 may be integrally mounted with the shock absorber 22. Alternatively, the coil spring 26 may be separated from the shock absorber 22 to be supported between the lower arm 14 and the vehicle body 10.

In the meantime, the regenerative damping apparatus 30 comprises an electric generator 32 mounted to one side of the vehicle body, that is, to the cross member 12. The electric generator 32 includes a rotor 34 rotatably mounted in a housing 33, and a coil 35 mounted to surround the rotor 34. The rotor 34 has a permanent magnet, so that, as the rotor is rotated, the electricity is generated along the coil 35.

The regenerative damping apparatus 30 comprises a suspension link 36 for converting the shock and/or the vibration transmitted from the outside into the rotational force of the rotor 34. One end of the suspension link 36 is connected to the lower arm 14, and the other end of the suspension link 36 is connected to the rotor 34 of the electric generator 32. Two suspension links 36 may be mounted to the right and the left road wheels, respectively.

The lower arm 14 to which the one end of the suspension link 36 is connected may be pivoted upward and downward by the shock transmitted from the outside when the vehicle is driven. The upward/downward pivoting of the lower arm 14 allows the suspension link 36 to rotate within a certain angle range around a rotational axial line of the rotor 34. As shown in FIG. 2, since the electric generator 32 is mounted at a place which is spaced apart from the lower arm 14 by a certain distance in the lengthwise direction of the vehicle, a moment can be exerted to the suspension link 36 for connecting the lower arm 14 and the electric generator 32 to each other when the lower arm 14 is pivoted upward and downward.

In other words, the vibration and/or the shock of the vehicle body allows the suspension link 36 to be rotated within a certain angle range. Due to the frictional force generated during the rotational motion of the suspension link 36, the suspension link 36 may serve as an auxiliary spring which supports the road wheel 26.

The one end of the suspension link 36, which is connected to the lower arm 14, is moved upward and downward by means of the vibration and/or the shock transmitted from the road surface. As a result, the other end of the suspension link 36, which is mounted to the vehicle body, is rotated. As illustrated above, the rotational motion generated at the other end of the suspension link 36 allows the rotor 34 of the electric generator 32 to be rotated, so that the electricity is generated along the coil 35.

Preferably, a velocity-increaser 37 which serves as a transmission may be mounted between the suspension link 36 and the rotor 34 of the electric generator 32. This velocity-increaser 37 can increase the velocity of the rotational motion transmitted from the suspension link 36. Even though the rotational angle of the suspension link 36 is small, the velocity-increaser 37 may increase the rotation angle of the rotor 34 (that is, the revolution per minute thereof) so that the revolution per minute may increase enough to generate the electricity. In addition, the electricity generated in the electric generator 32 may be supplied to and utilized in a battery charger or an electrical device in the vehicle.

As descried above, the regenerative damping apparatus 30 according to the present disclosure can regenerate the vibration energy and/or the shock energy transmitted from the road surface into the electrical energy.

In the meantime, the electric generator 32 serves as a motor, if necessary, so that the electric generator 32 may be utilized alone or together with the shock absorber 22 for enhancing the driving comfort of the vehicle and the steering stability of the vehicle.

That is, the electric generator 32 can control the current in the reverse direction to allow the rotational force to be exerted on the rotor 34. If the rotational force is generated in the rotor 34, the other end of the suspension link 36 may be rotated, so that it is possible to restrict the movement of the lower arm 14 to which the one end of the suspension linker 36 is connected. At this time, the velocity-increaser 37 may serve as a velocity-reducer.

Accordingly, the electric generator 32 may be operated to exert a force to the suspension link 36, so that the electric generator can be utilized for optimally controlling the driving conditions of the vehicle, that is, the posture of the vehicle and the stability thereof.

To this end, an electric power source 41 for supplying the coil 35 with current is connected to the electric generator 32, and the vehicle may include an electronic control unit (ECU) 42 for controlling the current to be supplied from the electric power source 41 to the coil 35.

The electronic control unit 42 receives the information on the driving conditions of the vehicle from the various sensors such as a wheel velocity sensor, a steering angle sensor, a lateral acceleration sensor and the like, and controls the operation of the electric generator 32 according to the driving conditions of the vehicle. Accordingly, the electronic control unit 42 may be used to actively control the motion conditions of the suspension link 35, so that the damping force of the vehicle may be adjusted and the driving comfort of the vehicle and the steering stability thereof may be simultaneously controlled.

In other words, the electronic control unit 42 in the electric generator 32 may be controlled to allow the current supplied to the coil 35 to be varied, so that the rotor 34 and the suspension link 36 connected to the rotor 34 may be rotated, and therefore the rotational force in the suspension link 36 may allow the one end of the suspension link 36 to be pivoted upward and downward so that the lower arm 14 may be pressurized. As such, the vibration of the vehicle may be damped with the force alone to be exerted to the lower arm 14 upward and downward by means of the suspension link 36 as described above or together with the damping force of the shock absorber. In addition, the electronic control unit 42 may control each of the suspension links 36 mounted to the right and the left road wheels to prevent the roll phenomenon of the vehicle from being generated.

The regenerative damping apparatus according to the present disclosure constructed as described above solves the drawbacks of the linear-type regenerative damping apparatus so that the rotation of the suspension link allows the electric generator to regenerate the energy which would be lost. Accordingly, the noise to be generated may be reduced, and the driving comfort and the driving performance may be enhanced the regenerative damping apparatus may be mounted together with the conventional shock absorber to enhance the driving comfort and the driving performance.

In addition, the regenerative damping apparatus according to the present disclosure may control the electric generator to rotate the suspension link.

Accordingly, the output of electric generator in the regenerative damping apparatus according to the present disclosure may be adjusted so that the reaction force of the suspension link may be controlled, thereby capable of controlling the damping force.

The scope of the present disclosure is not limited to the embodiment described and illustrated above but is defined by the appended claims. It will be apparent that those skilled in the art can make various modifications and changes thereto within the scope of the disclosure defined by the claims. Therefore, the true scope of the present disclosure should be defined by the technical spirit of the appended claims.

What is claimed is:

1. A regenerative damping apparatus for a vehicle for damping vibration transmitted from a road surface and regenerating vibration energy of a vehicle into electrical energy when the vehicle is driven, comprising;
an electric generator mounted to a vehicle body at a place spaced apart from a lower arm by a certain distance in the lengthwise direction of the vehicle, the lower arm having one end mounted to the vehicle body pivotally upward and downward and the other end connected to a road wheel to support the road wheel; and
a suspension link having one end connected to the lower arm and the other end connected to the electric generator,
wherein when the lower arm is pivoted upward and downward, the suspension link rotates around a central axis of the electric generator so that the electricity is generated.

2. The regenerative damping apparatus as claimed in claim 1, further comprising a transmission mounted between the electric generator and the other end of the suspension link to change a rotational speed.

3. The regenerative damping apparatus as claimed in claim 1, wherein the electric generator includes:
a rotor rotatably mounted to a housing and having a permanent magnet; and
a coil surrounding the rotor to generate the electricity when the rotor rotates.

4. The regenerative damping apparatus as claimed in claim 3, wherein the electric generator further includes:
an electric power source for supplying the coil with current; and
an electronic control unit for controlling the current to be supplied to the coil,
wherein the current supplied to the coil in the electric generator rotates the rotor and the suspension link connected thereto so that damping force at the road wheel is changed.

5. The regenerative damping apparatus as claimed in claim 3, further comprising a shock absorber or a coil spring mounted between the vehicle body and the road wheel.
